(19) United States
(12) Patent Application Publication
(10) Pub. No.: US 2012/0147224 A1
(43) Pub. Date: Jun. 14, 2012

(54) IMAGING APPARATUS

(75) Inventor: Tomohiko Takayama, Kawasaki-shi (JP)

(73) Assignee: CANON KABUSHIKI KAISHA, Tokyo (JP)

(21) Appl. No.: 13/302,349

(22) Filed: Nov. 22, 2011

(30) Foreign Application Priority Data
Dec. 8, 2010 (JP) 2010-273386
Aug. 24, 2011 (JP) 2011-183092

(51) Int. Cl. H04N 5/217

(52) U.S. Cl. 348/241; 348/E05.078

(57) ABSTRACT

An imaging apparatus has image sensors, an imaging optical system of which relative position with the image sensors is fixed, and a merging unit which connects images obtained by imaging while changing the relative position between the image sensors and the imaging optical system. Aberration of the imaging optical system in an image obtained by each image sensor is predetermined based on the relative position between the imaging optical system and the image sensor. The merging unit smoothes seams of the two images by setting a correction area in an overlapped area where the two images to be connected overlap with each other, and performing correction processing on pixels in the correction area. A size of the correction area is determined according to the difference in aberrations of the two images, which is determined by a combination of image sensors which have imaged the two images.

### BACKGROUND OF THE INVENTION

1. Field of the Invention

The present invention relates to a technology of dividing and imaging an object by using a plurality of image sensors which are discretely arranged, and generating a large sized image by merging the plurality of divided images.

2. Description of the Related Art

In the field of pathology, a virtual slide apparatus is available, where a sample placed on a slide is imaged, and the image is digitized so as to make possible a pathological diagnosis based on a display. This is used instead of an optical microscope, which is another tool used for pathological diagnosis. By digitizing an image for pathological diagnosis using a virtual slide apparatus, a conventional optical microscope image of the sample can be handled as digital data. The expected merits of this are: a quick remote diagnosis, a description of a diagnosis for a patient using digital images, a sharing of rare cases, and making education and practical training efficient.

In order to digitize the operation with an optical microscope using the virtual slide apparatus, the entire sample on the slide must be digitized. By digitizing the entire sample, the digital data created by the virtual slide apparatus can be observed by viewer software, which runs on a PC and WS. If the entire sample is digitized, however an enormous number of pixels are required, normally several hundred million to several billion. Therefore in a virtual slide apparatus, an area of a sample is divided into a plurality of areas, and is imaged using a two-dimensional image sensor having several hundred thousand to several million pixels, or using a one-dimensional image sensor having several thousand pixels. To generate an image of the entire sample, a technology to merge (connect) the divided images, while considering distortion and shift of images due to aberration of the lenses, is required.

As an image merging technology, the following technology has been proposed (see Japanese Patent Application Laid-Open No. H06-004660 and Japanese Patent Application Laid-Open No. 2010-050842). Japanese Patent Application Laid-Open No. H06-004660 discloses a technology on an image merging apparatus for generating a panoramic image, wherein aberration is corrected at least on an overlapped area of the image based on estimated aberration information, and each of the corrected images is merged. Japanese Patent Application Laid-Open No. 2010-050842 discloses a technology to side step the parallax phenomena by dynamically changing the stitching points according to the distance between a multi-camera and an object, so as to obtain a seamless wide angle image.

In conventional image merging technology, it is common to connect two images by creating an overlapped area (seams) between adjacent images, and performing image correction processing (pixel interpolation) on the pixels in the overlapped area. An advantage of this method is that the joints of the images can be unnoticeable, but a problem is that resolution drops in the overlapped area due to image correction. Particularly in the case of the virtual slide apparatus, it is desired to obtain an image that faithfully reproduces the original, minimizing resolution deterioration due to image correction, in order to improve diagnostic accuracy in pathological diagnosis.

In the case of Example 1 of Japanese Patent Application Laid-Open No. H06-004660, however, an area where blur is generated due to image interpolation is decreased by correcting the distortion in the overlapped area, where a same area is imaged by two images, but the area depends on the overlapped area between the two images which is the overlapped area itself. In this patent application, nothing is disclosed about a further decrease of the correction area within the overlapped area.

In the case of Example 2 of Japanese Patent Application Laid-Open No. H06-004660, an example of smoothly merging images by changing the focal length value upon rotational coordinate transformation is disclosed, but this does not decrease the correction area itself.

In the case of Example 3 in Japanese Patent Application Laid-Open No. H06-004660, a correction curve is determined based on the estimated aberration information, but the estimated aberration information is not reflected in a method of determining the correction range, since points not to be corrected are predetermined.

In Japanese Patent Application Laid-Open No. 2010-050842, the influence of image distortion due to aberration of the lens and how to determine the correction area are not disclosed. Although a seamless wide angle image can be obtained, the problem is that resolution deteriorates in the image merging area due to image interpolation.

### SUMMARY OF THE INVENTION

With the foregoing in view, it is an object of the present invention to provide a configuration to divide and image an object using a plurality of image sensors which are discretely arranged, and generate a large sized image by merging the plurality of divided images, wherein deterioration of resolution due to merging is minimized.

The present invention provides an imaging apparatus including: a supporting unit which supports an object; an imaging unit which has a plurality of image sensors discretely disposed with spacing from one another; an imaging optical system which enlarges an image of the object and guides the image to the imaging unit, and of which relative position with the plurality of image sensors is fixed; a moving unit which changes the relative position between the plurality of image sensors and the object, so as to perform a plurality of times of imaging while changing imaging positions of the plurality of image sensors with respect to the image of the object; and a merging unit which connects a plurality of images obtained from respective image sensors at respective imaging positions, and generates an entire image of the object, wherein aberration of the imaging optical system in an image obtained by each image sensor is predetermined for each image sensor based on the relative position between the imaging optical system and the image sensor, the moving unit changes the relative position between the plurality of image sensors and the object so that the two images to be connected partially overlap, the merging unit smoothes seams of the two images by setting a correction area in an overlapped area where the two images to be connected overlap with each other, and performing correction processing on pixels in the correction area, and a size of the correction area is determined according to the difference in aberrations of the two images, which is determined by a combination of image sensors which have imaged the two images to be connected.

The present invention can provide a configuration to divide and image an object using a plurality of image sensors which are discretely arranged, and generate a large sized image by merging the plurality of divided images, wherein deterioration of resolution due to merging is minimized.

Further features of the present invention will become apparent from the following description of exemplary embodiments with reference to the attached drawings.

### BRIEF DESCRIPTION OF THE DRAWINGS

FIGS. 1A to 1C are schematic diagrams depicting a general configuration related to imaging of an imaging apparatus;

FIGS. 2A and 2B are schematic diagrams depicting an imaging sequence;

FIGS. 3A and 3B are flow charts depicting image data reading;

FIG. 4 is a functional block diagram depicting a divided imaging and image data merging;

FIGS. 5A and 5B are schematic diagrams depicting an image data merging areas;

FIG. 6 is a schematic diagram depicting an operation sequence of the image data merging;

FIGS. 7A and 7B are schematic diagrams depicting an example of distortion and a combination of images in merging;

FIGS. 8A to 8C are schematic diagrams depicting a correction area;

FIGS. 9A to 9C are schematic diagrams depicting a relative difference of shift of the first image and that of the second image from the true value;

FIG. 10 is a flow chart depicting a flow to determine a correction area and an overlapped area;

FIG. 11 is a flow chart depicting calculation of the relative coordinate shift amount;

FIG. 12 is a flow chart depicting determination of the overlapped area;

FIGS. 13A and 13B are schematic diagrams depicting an example of the correction method;

FIGS. 14A and 14B are diagrams depicting interpolation coordinates and reference coordinates;

FIGS. 15A and 15B are flow charts depicting flows of the coordinate transformation processing and the pixel interpolation processing;

FIGS. 16A to 16C are schematic diagrams depicting a correction area according to the second embodiment; and

FIGS. 17A to 17D are schematic diagrams depicting a correction area according to the third embodiment.

### DESCRIPTION OF THE EMBODIMENTS

### First Embodiment

### Configuration of Imaging Apparatus

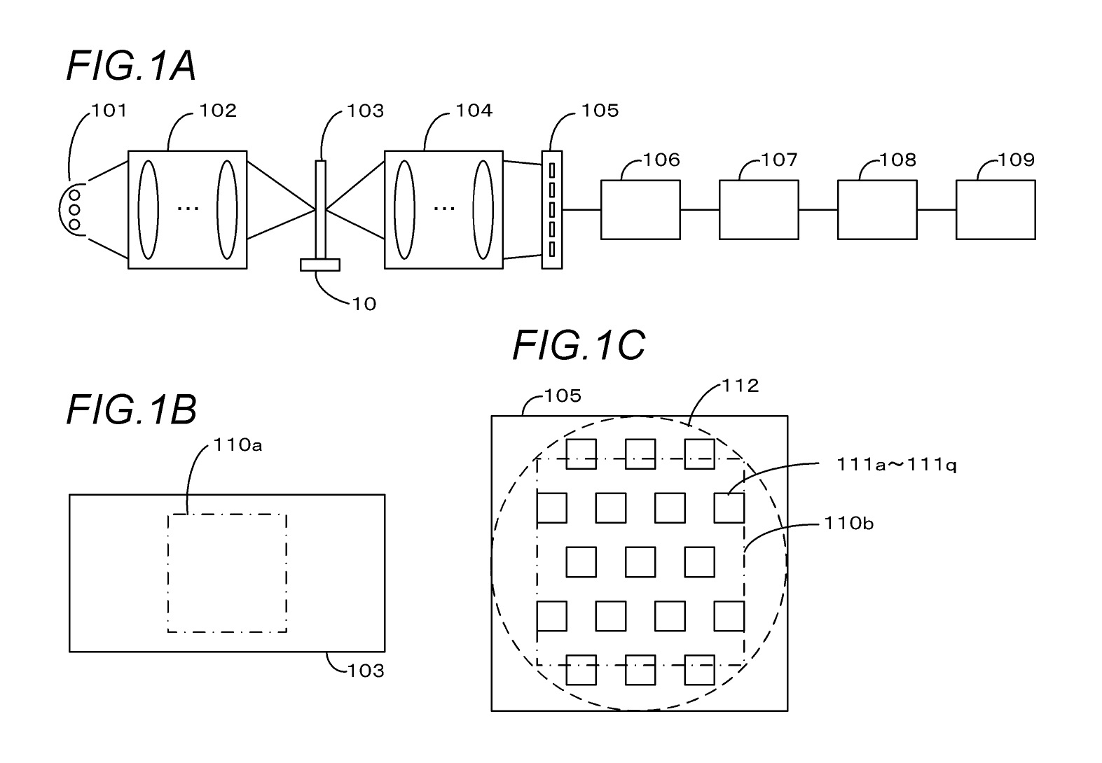

FIG. 1A to FIG. 1C are schematic diagrams depicting a general configuration related to imaging of an imaging apparatus. This imaging apparatus is an apparatus for acquiring an optical microscopic image of a sample on a slide 103 as a high resolution digital image.

As FIG. 1A illustrates, the imaging apparatus is comprised of a light source 101, an illumination optical system 102, a moving mechanism 10, an imaging optical system 104, an imaging unit 105, a development/correction unit 106, a merging unit 107, a compression unit 108 and a transmission unit 109. The light source 101 is a means of generating illumination light for imaging, and a light source having emission wavelengths of three colors, RGB, such as an LED (Light Emitting Diode) and an LD (Laser Diode) can be suitably used. The light source 101 and the imaging unit 105 operate synchronously. The light source 101 sequentially emits the lights of RGB, and the imaging unit 105 exposes and acquires each RGB image respectively, synchronizing with the emission timings of the light source 101. One captured image is generated from each RGB image by the development/correction unit 106 in the subsequent step. The illumination optical system 102 guides the light of the light source 101 efficiently to an imaging target area 110a on the slide 103.

The slide 103 is a supporting unit to support a sample to be a target of pathological diagnosis. And the slide 103 has a slide glass on which the sample is placed and a cover glass with which the sample is sealed using a mounting solution. FIG. 1B shows only the slide 103 and the imaging target area 110a which is set thereon. The size of the slide 103 is about 76 mm×26 mm, and the imaging target area of a sample, which is an object, is assumed to be 20 mm×20 mm here.

The imaging optical system 104 enlarges (magnifies) the transmitted light from the imaging target area 110a on the slide 103, and guides the light and forms an imaging target area image 110b, which is a real image of the imaging target area 110a on the surface of the imaging unit 105. The effective field of view 112 of the imaging optical system has a size that covers an image sensor group 111a to 111q, and the imaging target area 110b.

The imaging unit 105 is an imaging unit constituted by a plurality of two-dimensional image sensors which are discretely arrayed two-dimensionally in the X direction and the Y direction, with spacing therebetween. Seventeen two-dimensional image sensors are used in the present embodiment, and these image sensors may be mounted on a same board or on separate boards. To distinguish an individual image sensor, an alphabetic character is attached to the reference number, that is, from a to c, sequentially from the left, in the first row, d to g in the second row, h to j in the third row, k to n in the fourth row, and o to q in the fifth row, but for simplification, image sensors are denoted as “111a to 111q” in the drawings. This is the same for the other drawings.

FIG. 1C illustrates the positional relationships of the image sensor group 111a to 111q, the imaging target area image 110b on the imaging plane and the effective field of view 112 of the imaging optical system. The positional relationship of the image sensor group 111a to 111q and the effective field of view 112 of the imaging optical system is fixed, but the relative position of the imaging target area image 110b on the imaging plane with respect to the image sensor group 111a to 111q and the effective field of view 112 changes by a moving mechanism 10, which is disposed at the slide side. In the present embodiment, the moving axis is uniaxial, so that the moving mechanism has a simple configuration, lower cost and higher accuracy. In other words, a plurality of imaging is performed while moving the relative position of the image sensor group 111a to 111q and the imaging target area image 110b on the image plane in uniaxial direction (Y direction), and a plurality of digital data (RAW data) are acquired.

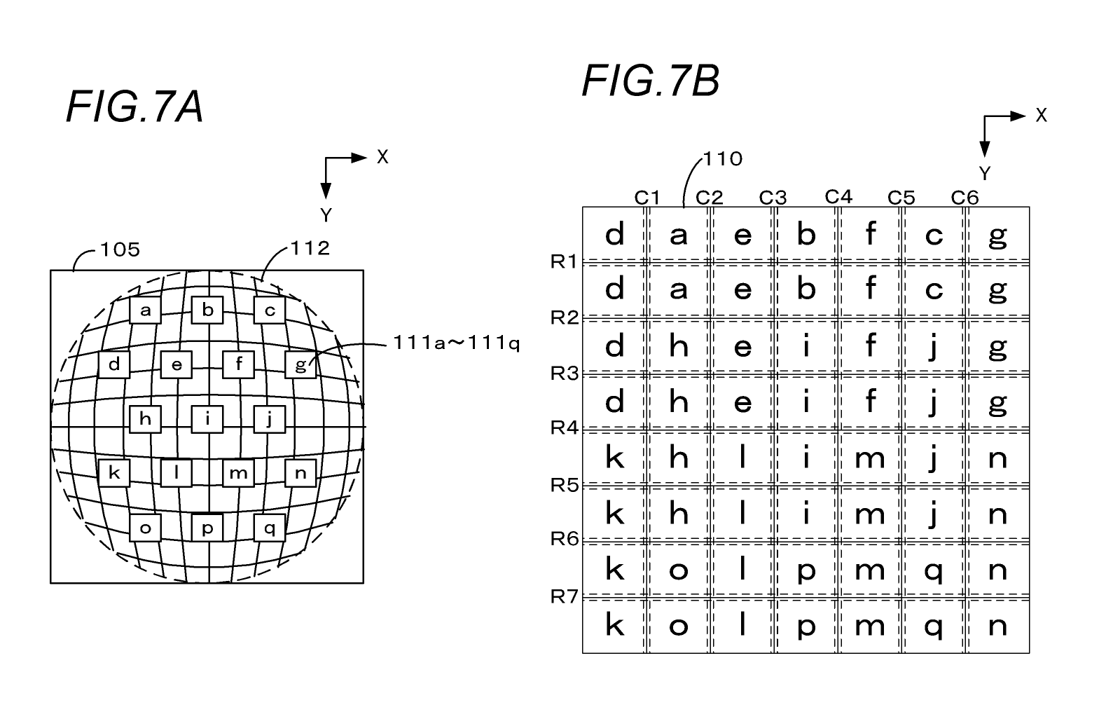

The development/correction unit 106 performs the development processing and the correction processing of the digital data acquired by the imaging unit 105. The functions thereof include black level correction, DNR (Digital Noise Reduction), pixel defect correction, brightness correction due to individual dispersion of image sensors and shading, development processing, white balance processing and enhancement processing. The merging unit 107 performs processing to merge a plurality of captured images which are output from the development/correction unit 106. The joint correction by the merging unit 107 is not performed for all the pixels, but only for an area where the merging processing is required. The merging processing will be described in detail with reference to FIG. 7 to FIG. 15.

The compression unit 108 performs sequential compression processing for each block image which is output from the merging unit 107. The transmission unit 109 outputs the signals of the compressed block image to a PC (Personal Computer) and WS (Workstation). For the signal transmission to a PC and WS, it is preferable to use a communication standard which allows large capacity transmission, such as gigabit Ethernet (registered trademark).

In a PC and WS, each received compressed block image is sequentially stored in a storage. To read a captured image of a sample, viewer software is used. The viewer software reads the compressed block image in the read area, and decompresses and displays the image on a display. By this configuration, a high resolution large screen image can be captured from about a 20 mm square sample, and the acquired image can be displayed.

(Imaging Procedure of Imaging Target Area)

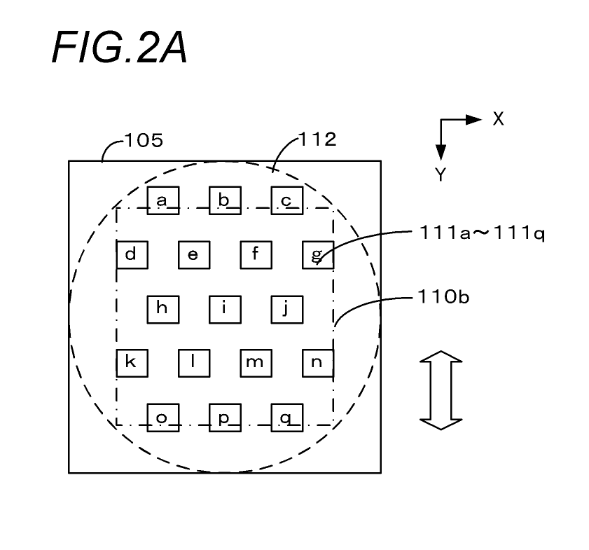

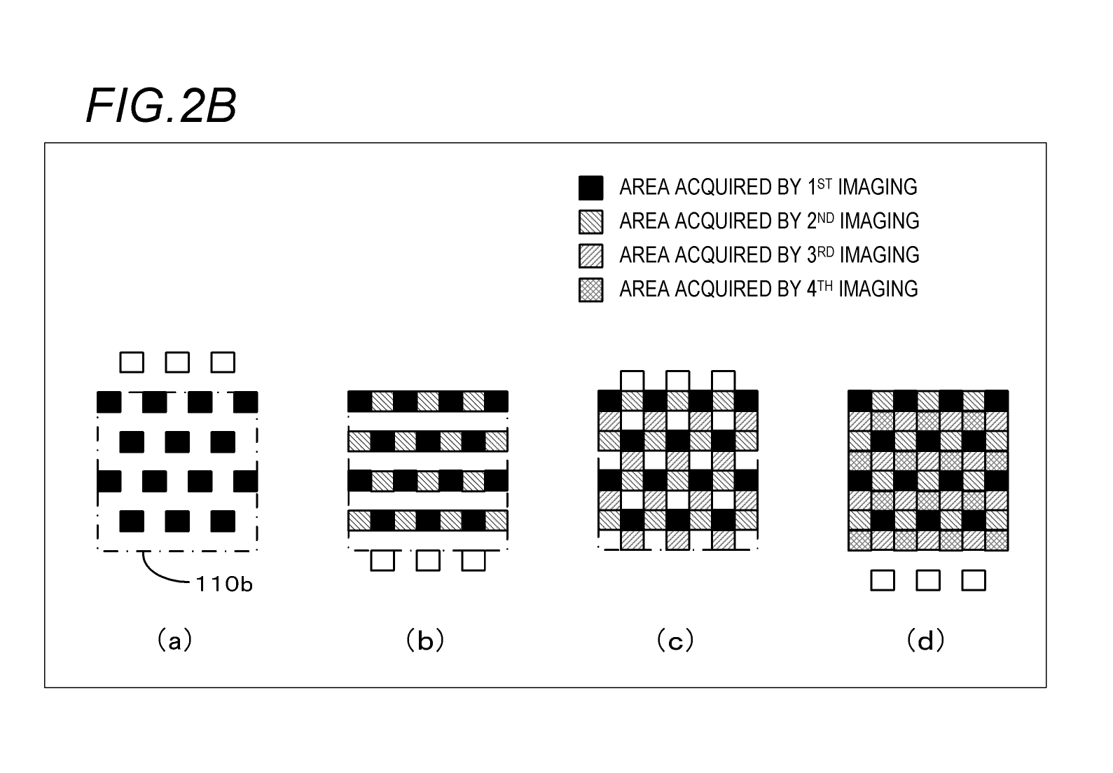

FIG. 2A and FIG. 2B are schematic diagrams depicting a flow of imaging the entire imaging target area with a plurality of times of uniaxial imaging. In order to execute the merging processing in the subsequent step using a simple sequence, the horizontal reading direction (X direction) of the image sensors and the moving direction (Y direction) are perpendicular, and the number of pixels to be read in the Y direction of the small imaging areas which are adjacent is roughly the same as reading in the X direction. The image sensor group 111a to 111q and the imaging target area image 110b on the imaging plane are controlled to move relatively, so that the image sensor group sequentially fill the imaging target area images along the Y direction. The merging processing will be described in detail with reference to FIG. 7 to FIG. 15.

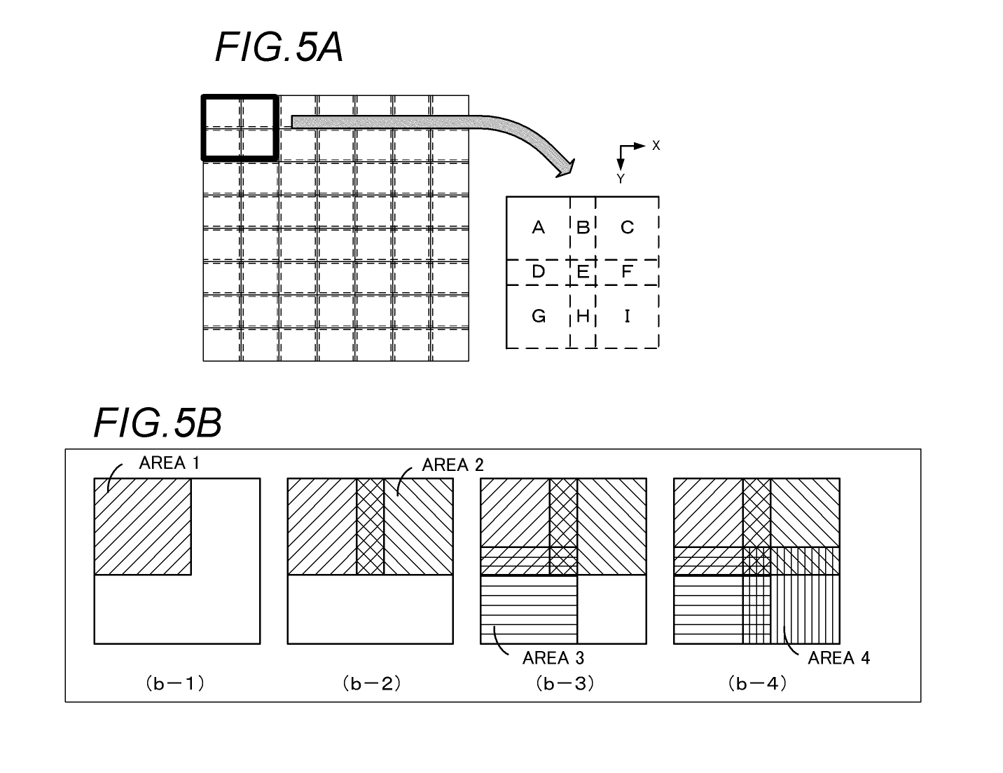

FIG. 2A is a schematic diagram depicting a positional relationship of the image sensor group 111a to 111q and the imaging target area image 110b on the imaging plane. The relative positions of the image sensor group 111a to 111q and the imaging target area image 110b on the imaging plane change in the arrow direction (Y direction) by the moving mechanism disposed on the slide side. FIG. 2B is a diagram depicting the transition of capturing the imaging target image 110b by the image sensor group 111a to 111q. Actually the imaging target area image 110b moves with respect to the image sensor group 111a to 111q by the moving mechanism 10 disposed on the slide side. In this illustration however, the imaging target area image 110b is fixed in order to describe how the imaging target area image 110b is divided and imaged. An overlapped area is required between adjacent image sensors, in order to correct the seams by the merging unit 107, but the overlapped area is omitted here to simplify description. The overlapped area will be described later with reference to FIGS. 5A and 5B.

In FIG. 2B-(a), an area obtained by the first imaging is indicated by black solid squares. In the first imaging position, each of RGB images is obtained by switching the emission wavelength of the light source. In FIG. 2B-(b), an area obtained by the second imaging, after moving the slide by the moving mechanism, is indicated by diagonal lines (slanted to the left). In FIG. 2B-(c), an area obtained by the third imaging is indicated by reverse diagonal lines (slanted to the right). In FIG. 2B-(d), an area obtained by the fourth imaging is indicated by half tones.

After performing imaging four times by the image sensor group (the moving mechanism moves the slide three times), the entire imaging target area can be imaged without any openings.

(Flow of Imaging Processing)

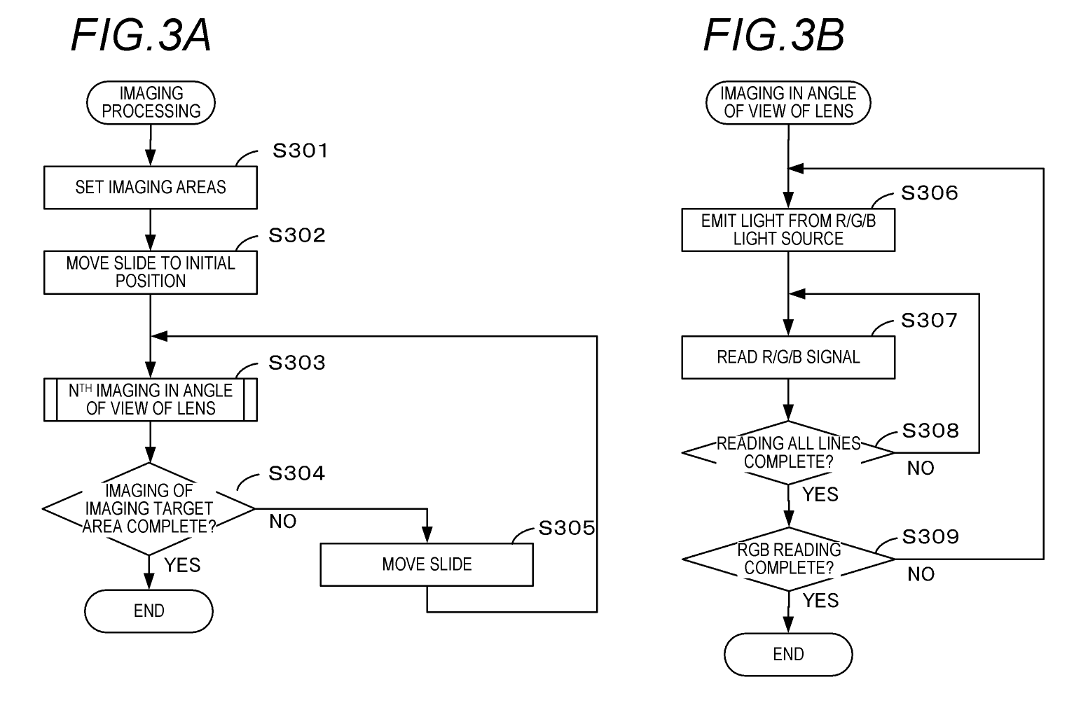

FIG. 3A and FIG. 3B are flow charts depicting a flow of imaging an entire imaging target area and reading of image data.

FIG. 3A shows a processing flow to image the entire imaging target area by a plurality of times of imaging.

In step S301, an imaging area is set. A 20 mm square area is assumed as the imaging target area, and the position of the mm square area is set according to the position of the sample on the slide.

In step S302, the slide is moved to the initial position where the first imaging (N=1) is executed. In the case of FIG. 2B, for example, the slide is moved so that the relative position of the image sensor group 111a to 111q and the imaging target area image 110 b on the imaging plane becomes the state shown in FIG. 2B-(a).

In step S303, an image is captured within an angle of lens view for the Nth time.

In step S304, it is determined whether imaging of the entire imaging target area is completed. If the imaging of the entire imaging target area is not completed, processing advances to S305. If the imaging of the entire imaging target area is completed, that is, if N=4 in the case of this embodiment, the processing ends.

In step S305, the moving mechanism moves the slide so that the relative position of the image sensor group and the imaging target area image becomes a position for executing imaging for the Nth time (N≧2).

FIG. 3B shows a detailed processing flow of the image capturing within an angle of lens view in step S303. In the present embodiment, a case of using the rolling shutter type image sensors will be described.

In step S306, emission of a single color light source (R light source, G light source or B light source) is started, and the light is irradiated onto the imaging target area on the slide.

In step S307, the image sensor group is exposed, and single color image signals (R image signal, G image signals or B image signals) are read. Because of the rolling shutter method, the exposure of the image sensor group and the reading signals are executed line by line. The lighting timing of the single color light source and the exposure timing of the image sensor group are controlled so as to operate synchronously. The single color light source starts emission at the timing of the start of exposure of the first line of the image sensors, and continues the emission until exposure of the last line completes. At this time, it is sufficient if only the image sensors which capture images, out of the image sensor group, operate. In the case of FIG. 2B-(a), for example, it is sufficient if only the image sensors blotted out in black operate, and the three image sensors on the top, which are outside the imaging target area image, need not operate.

In step S308, it is determined whether the exposure and the reading signals are completed for all the lines of the image sensors. The processing returns to S307 and continues until all the lines are completed. When all the lines are completed, processing advances to S309.

In step S309, it is determined whether the imaging of all the RGB images completed. If imaging of each image of RGB is not completed, processing returns to S306, and processing ends if completed.

According to these processing steps, the entire imaging target area is imaged by imaging each image of RGB 4 times respectively.

(Image Merging)

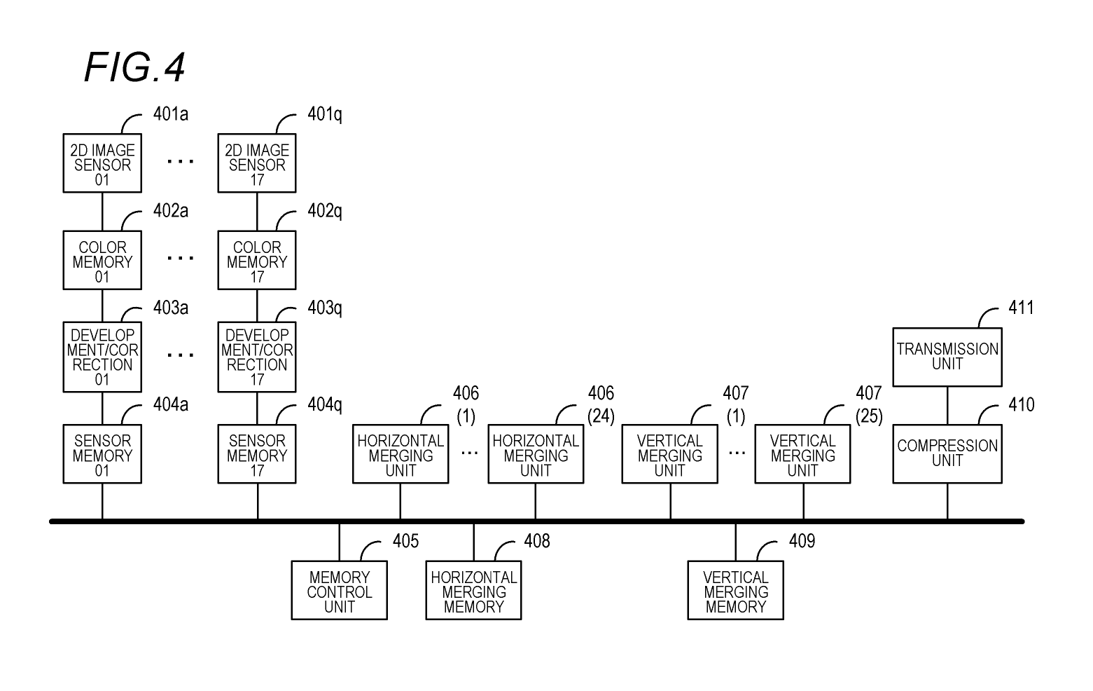

FIG. 4 is a functional block diagram depicting divided imaging and an image merging method. To simplify description of the image merging, the functional blocks of the two-dimensional image sensor group and the functional blocks related to the merging processing are shown separately. The functional blocks of the image merging method include two-dimensional image sensors 401a to 401q, color memories 402a to 402q, development/correction units 403a to 403q, sensor memories 404a to 404q, a memory control unit 405, a horizontal direction merging unit 406, a vertical direction merging unit 407, a horizontal merging memory 408, a vertical merging memory 409, a compression unit 410 and a transmission unit 411.

FIG. 4 to FIG. 6 are described based on the assumption that the horizontal reading direction (X direction) of the image sensors and the moving direction (Y direction) are perpendicular, and the number of reading pixels in the Y direction of the imaging areas, which are adjacent, is roughly same as the reading in the X direction as described in FIG. 2B.

The two-dimensional image sensors 401a to 401q correspond to the two-dimensional image sensor group 111a to 111q described in FIG. 2A. The entire imaging target area is imaged while changing the relative positions of the image sensor group 111a to 111q and the image target area image 110b on the imaging plane, as described in FIG. 2B. The color memories 402a to 402q are memories for storing each image signal of RGB, which are attached to the two-dimensional image sensors 401a to 401q respectively. Since image signals of three colors RGB are required for the development/correction units 403a to 403q in the subsequent step, a memory capacity that can store at least two colors of image signals, out of the R image signal, G image signal and B image signal, is necessary.

The development/correction units 403a to 403q perform the development processing and correction processing on the R image signal, G image signal and B image signal. The functions thereof include black level correction, DNR (Digital Noise Reduction), pixel defect correction, brightness correction due to individual dispersion of image sensors and shading, development processing, white balance processing and enhancement processing.

The sensor memories 404a to 404q are frame memories for temporarily storing developed/corrected image signals.

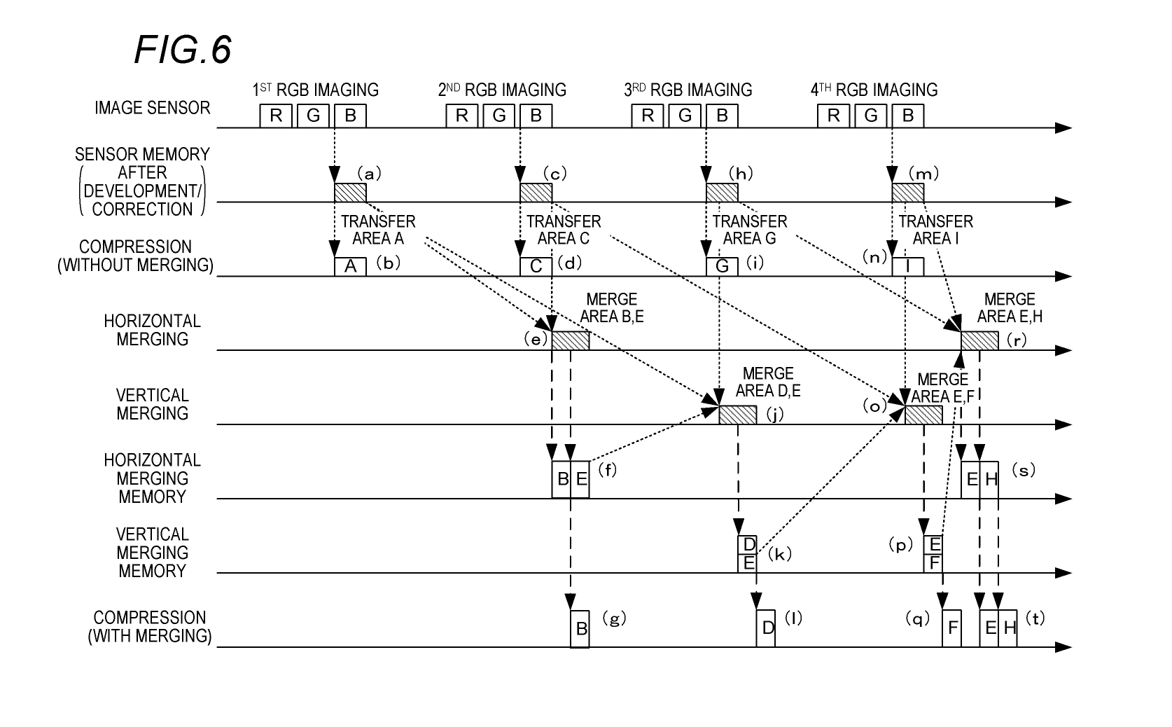

The memory control 405 specifies a memory area for image signals stored in the sensor memories 404a to 404q, controls to transfer the image signals to one of the compression unit 410, horizontal direction merging unit 406 and vertical direction merging unit 407. The operation of memory control will be described in detail with reference to FIG. 6.

The horizontal direction merging unit 406 performs merging processing for image blocks in the horizontal direction. The vertical direction merging unit 407 performs merging processing for image blocks in the vertical direction. The merging processing in the horizontal direction and the merging processing in the vertical direction are executed in the overlapped areas between adjacent image sensors. The overlapped area will be described later with reference to FIGS. 5A and 5B. The horizontal merging memory 408 is a memory which temporarily stores image signals after the horizontal merging processing. The vertical merging memory 409 is a memory which temporarily stores image signals after the vertical merging processing.

The compression unit 410 sequentially performs compression processing on image signals transferred from the sensor memories 404a to 404q, the horizontal merging memory 408 and the vertical merging memory 409, for each transfer block. The transmission unit 411 converts the electric signals of the compressed block image into light signals, and outputs the signals to a PC and WS.

Because of the above configuration, an image of the entire imaging target area can be generated from the image discretely acquired by the two-dimensional image sensors 401a to 401q, by the merging processing.

FIGS. 5A and 5B are schematic diagrams depicting the image data merging areas. As described in FIG. 2B, an image is obtained sequentially and discretely by the two-dimensional image sensors 111a to 111q. Since seams are corrected by the merging unit 107, adjacent images to be connected are imaged so that the images partially overlap with each other. FIGS. 5A and 5B show the overlapped areas.

FIG. 5A is a diagram of the entire imaging target area and a diagram when a part of the entire imaging target area is extracted. Here it is shown how the imaging target area is divided and imaged spatially, ignoring the time concept. The broken line indicates the overlapped area of each captured image and the area is illustrated emphatically. For simplification, the diagram of the extracted part of the entire imaging target area will be described. Here the areas imaged by a single two-dimensional image sensor are an area 1 (A, B, D, E), an area 2 (B, C, E, F), an area 3 (D, E, G, H) and an area 4 (E, F, H, I), which are imaged at different timings respectively. In terms of accuracy, pixels for the overlapped area exist in the top portion and left portion of the area 1, the top portion and right portion of the area 2, the left portion and bottom portion of the area 3, and the right portion and bottom portion of the area 4, but these areas are omitted here in order to simplify the description of the merging of images.

FIG. 5B illustrates how the imaging area is acquired as an image when the areas 1 to 4 are acquired in the time sequence of (b-1) to (b-4), as described in FIG. 2B. In (b-1), the area 1 (A, B, D, E) is imaged and acquired as an image. In (b-2), the area 2 (B, C, E, F) is imaged and acquired as an image. Here the area (B, E) is an area imaged as overlapping, and is an area where image merging processing in the horizontal direction is performed. In (b-3), the area 3 (D, E, G, H) is imaged and acquired as an image. Here, the area (D, E) is an area imaged as overlapping. In (b-2) the image merging processing in the vertical direction is performed for the area (D, E), assuming that one image of the area (A, B, C, D, E, F) has been acquired. In this case, the X direction is the horizontal read direction of the two-dimensional image sensors, so image merging processing in the vertical direction can be started before acquiring (more specifically, at the time of obtaining data D and E) the images of all of the area 3 (D, E, G, H). In (b-4), the area 4 (E, F, H, I) is imaged and acquired as an image. Here the area (E, F, H) is an area imaged as overlapping. In (b-3), image merging processing in the vertical direction for the area (E, F) and image merging processing in the horizontal direction for the area (E, H) are performed sequentially, assuming that one image of the area (A, B, C, D, E, F, G, H) has been acquired. In this case, the X direction is the horizontal read direction of the two-dimensional image sensors, so image merging processing in the vertical direction can be started before acquiring (more specifically, at the time of acquiring data E and F) the images of the area 4 (E, F, H, I).

The number of read pixels in the Y direction is roughly the same for the adjacent imaging areas in the X direction, therefore the image merging processing can be performed for each area (A to I) and the applied range can be easily expanded to the entire imaging target area. Since the imaging areas are acquired in such a ways as the image sensor group sequentially filling the imaging target area image along the Y direction, the image merging processing can be implemented with simple memory control.

A partial area extracted from the entire imaging target area was used for description, but the description on the areas where image merging is performed and the merging direction can be applied to the range of the entire imaging target area.

FIG. 6 is a diagram depicting an operation sequence of image merging. The time axis is shown for each functional block, illustrating how the areas A to I described in FIG. 5 are processed as time elapses. In this example, light sources are emitted in the sequence of R, G and B. Control here is performed by the memory control unit 405.

In (a), the R image and G image are captured for the first time, and in a state where the R image and the G image are stored in the color memories 402d to 402q respectively, and the B image is captured and sequentially read. In the development/correction units 403d to 403q, the R image and the G image are read from the color memories 402d to 402q synchronizing with the B image which is read from the two-dimensional image sensor, and development and correction processing is sequentially performed. An image on which the development and correction processing was performed is sequentially stored in the sensor memories 404d and 404q. The images stored here are the area (A, B, D, E).

In (b), the image of area (A), out of the area (A, B, D, E) stored in the sensor memories 404d to 404q in (a), is transferred to the compression unit 410. The merging processing is not performed for the area (A).

In (c), the R image and G image are captured for the second time, and in a state where the R image and the G image are stored in the color memories 402a to 402n respectively, and the B image is captured and sequentially read. In the development/correction units 403a to 403n, the R image and the G image are read from the color memories 402a to 402n, synchronizing with the B image which is read from the two-dimensional image sensor, and development and correction processing is sequentially performed. An image on which the development and correction processing was performed is sequentially stored in the sensor memories 404a to 404n. The images stored here are the area (B, C, E, F).

In (d), the image of the area (C), out of the area (B, C, E, F) stored in the sensor memories 404a to 404n in (c), is transferred to the compression unit 410. The merging processing is not performed for the area (C).

In (e), the area (B, E) is read from the sensor memories 404a to 404q, and image merging processing in the horizontal direction is performed.

In (f), the image after the image merging processing in the horizontal direction is sequentially stored in the horizontal merging memory 408.

In (g), the image of the area (B) stored in the horizontal merging memory 408 is transferred to the compression unit 410.

In (h), the R image and G image are captured for the third time, and in a state where the R image and G image are stored in the color memories 402d to 402q respectively, and the B image is captured and sequentially read. In the development/correction units 403d to 403q, the R image and the G image are read from the color memories 402d to 402q, synchronizing with the B image which is read from the two-dimensional image sensor, and the development and correction processing is sequentially performed. An image on which the development and correction processing was performed is sequentially stored in the sensor memories 404d to 404q. The image stored here is the area (D, E, G, H).

In (i), the image of the area (G), out of the area (D, E, G, H) stored in the sensor memories 404d to 404q in (h), is transferred to the compression unit 410. The merging processing is not performed for the area (G).

In (j), the image of the area (D, E) is read from the sensor memories 404d to 404q, and the horizontal merging memory 408, and the image merging processing in the vertical direction is performed.

In (k), the image after the image merging processing in the vertical direction is sequentially stored in the vertical merging memory 409.

In (l), the image of the area (D) stored in the vertical merging memory 409 is transferred to the compression unit 410.

In (m), the R image and G image are captured for the fourth time, and in a state where the R image and the G image are stored in the color memories 402a to 402n respectively, and the B image is captured and sequentially read. In the development/correction units 403a to 403n, the R image and the G image are read from the color memories 402a to 402n, synchronizing with the B image which is read from the two-dimensional image sensor, and the development and correction processing is sequentially performed. An image on which the development and correction processing was performed is sequentially stored in the sensor memories 404a to 404n. The image stored here is the area (E, F, H, I).

In (n), the image of the area (I), out of the area (E, F, H, I) stored in the sensor memories 404a to 404n in (m), is transferred to the compression unit 410. The merging processing is not performed for the area (I).

In (o), the area (E, F) is read from the sensor memories 404a to 404n and the vertical merging memory 409, and the image merging processing in the vertical direction is performed.

In (p), the image after the image merging processing in the vertical direction is sequentially stored in the vertical merging memory 409.

In (q), the image of the area (F) stored in the vertical merging memory 409 is transferred to the compression unit 410.

In (r), the area (E, H) is read from the sensor memories 404a to 404q and the vertical merging memory 409, and image merging processing in the horizontal direction is performed.

In (s), the image after the image merging processing in the horizontal direction is sequentially stored in the horizontal merging memory 408.

In (t), the image of the area (E, H) stored in the horizontal merging memory 408 is sequentially transferred to the compression unit 410.

In this way, the sequential merging processing can be performed by the memory control unit 405 controlling the memory transfer, and the image of the entire imaging target area can be transferred to the sequential compression unit 410.

Here the sequence of compression without merging processing was described for the areas (A), (C), (G) and (I), but the sequence of compression after joining areas with which the areas (A), (C), (G) and (I) are merged, can also be implemented.

### (Distortion)

FIGS. 7A and 7B are schematic diagrams depicting an example of distortion and combinations of images during merging.

FIG. 7A is a schematic diagram depicting an example of distortion. Since a relative positional relationship between the image sensor group 111a to 111q and the effective field of view 112 of the imaging optical system is fixed, each of the image sensors 111a to 111q has a predetermined distortion respectively. Distortions of the image sensors 111a to 111q are different from one another.

FIG. 7B is a schematic diagram depicting image combinations during merging, and shows an area, of the imaging target area image 110b, imaged by each image sensor. As described in FIG. 2B, the image sensor group 111a to 111q and the imaging target area image 110b on the imaging plane are controlled to relatively move so that the image sensor group sequentially fills the imaging target area image in the Y direction. Therefore the imaging target area image 110b is divided and imaged by each image sensor 111a to 111q. Alphabetic characters a to q, assigned to each divided area in FIG. 7B, indicate correspondence with the image sensors 111a to 111q which image the divided areas. Each image sensor 111a to 111q has a predetermined distortion, and the distortion is different between two images overlapping in each overlapped area. For example, in the case of the horizontal image merging of the first column (C1) of the overlapped areas, there are eight overlapped areas and there are four patterns of combinations of the image sensors: (d, a), (d, h), (k, h) and (k, o). In other words, in the case of the first column (C1) of the overlapped areas, there are four image connecting patterns. In the case of vertical image merging of the first row (R1) of the overlapped areas, there are seven overlapped areas and there are seven patterns of combinations of the image sensors: (d, d), (a, a), (e, e), (b, b), (f, f), (c, c) and (g, g). In the case of the first row (R1) of the overlapped areas, there are seven image connecting patterns, just like the above mentioned example. Since distortions are different between two images overlapping in each overlapped area, the imaging connecting method is also different depending on each overlapped area.

### (Correction Area)

In order to smoothly connect two images having different distortions, correction processing (processing to change coordinates of the pixels and pixel values) must be executed for the pixels in the overlapped area. A problem, however, is that resolution drops if the correction processing is executed, as mentioned above. Therefore according to the present embodiment, in order to minimize the influence of deterioration of resolution, correction processing is not executed for all the pixels of all the overlapped areas, but is executed only for a partial area (this area is hereafter called the “correction area”) of an overlapped area. At this time, the size of the correction area is determined according to the difference of distortions of the two images to be connected (this is determined depending on the combination of image sensors which captured the image). Deterioration of resolution can be decreased as the correction area size becomes smaller.

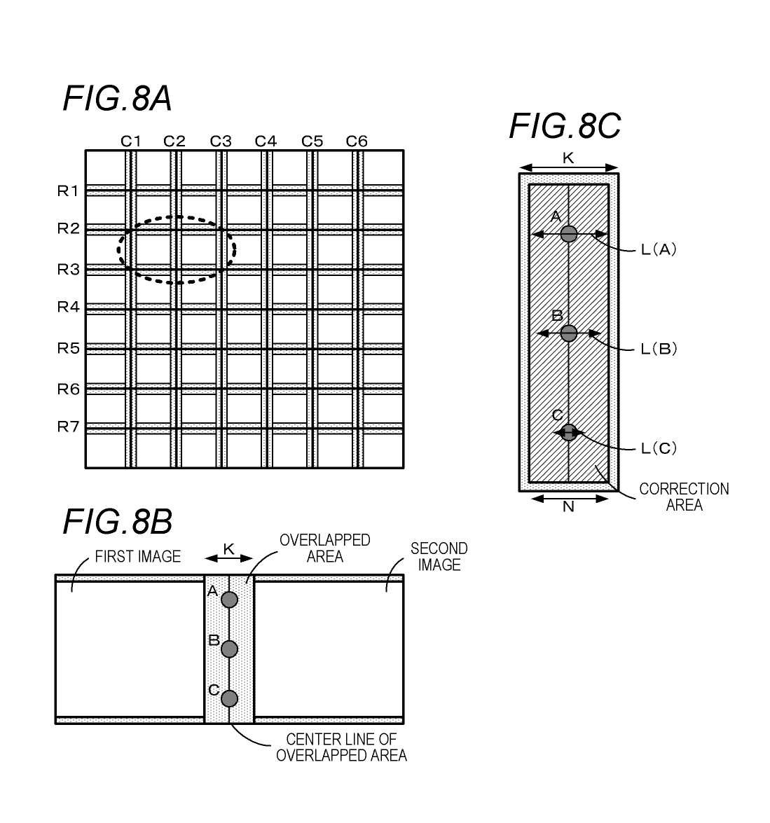

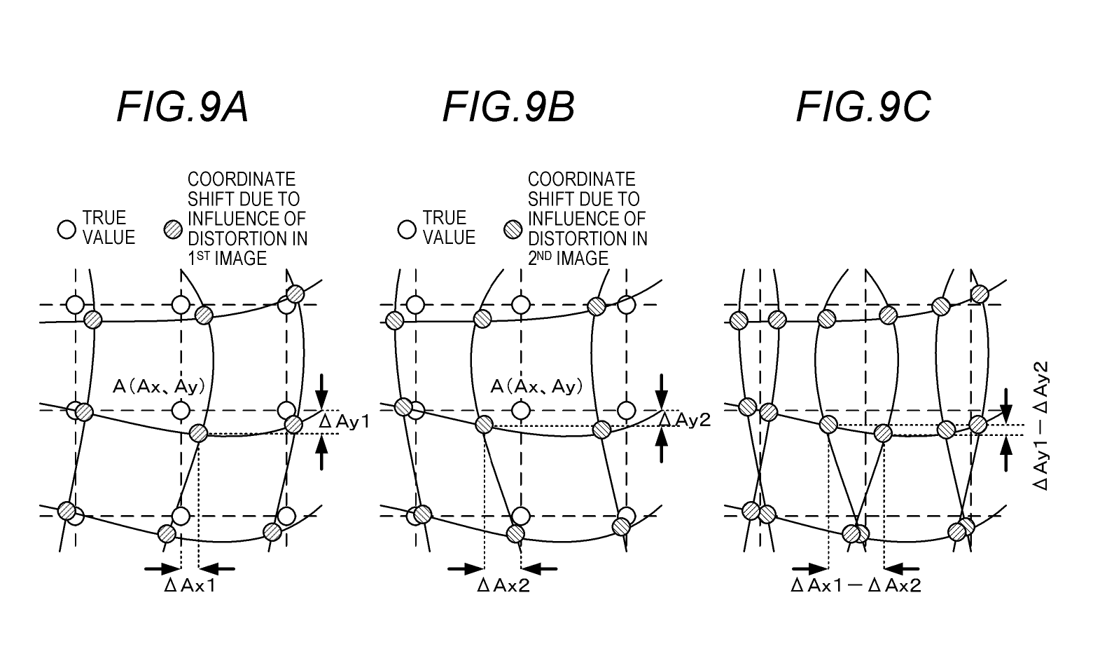

An example of a method for determining a correction area will be described with reference to FIGS. 8A to 8C and FIGS. 9A to 9C.

FIG. 8A shows an area of divided images generated by each image sensor, and corresponds to FIG. 5A and FIG. 7B.

FIG. 8B is a diagram extracting the dotted line portion of FIG. 8A, to consider horizontal image merging. Regarding the correspondence with FIG. 5A, the area in FIG. 8B corresponds to the areas (A, B, C, D, E, F) in FIG. 5A, where the first image corresponds to area 1 (A, B, D, E), the second image corresponds to area 2 (B, C, E, F), and the overlapped area corresponds to area (B, E). The overlapped areas located in the upper part of the first image and the second image are omitted in FIG. 5A to simplify description, but are shown in FIG. 8B.

Three representative points A, B and C on a center line of the overlapped area, of which width is K, are considered. In the correspondence with FIG. 7B, the first image is an image obtained by the image sensor 111h, and the second image is an image obtained by the image sensor 111e. Therefore the first image is influenced by the distortion caused by the arrangement of the image sensor 111h in the lens, and the second image is influenced by the distortion caused by the arrangement of the image sensor 111e in the lens.

FIG. 8C is a diagram extracting only the overlapped area from FIG. 8B.

L(A) is a width required for smoothing connecting the first image and the second image at a representative point A. L(A) is mechanically determined using a relative difference M(A) between the shift of the representative point A from the true value in the first image, and the shift of the representative point A from the true value in the second image. The shift from the true value refers to a coordinate shift which is generated due to the influence of distortion. In the case of FIG. 7A, the shift from the true value in the first image is the coordinate shift generated due to the distortion of the image sensor 111h, and the shift from the true value in the second image is the coordinate shift generated due to the distortion of the image sensor 111e.

It is assumed that the true value of the representative point A is (Ax, Ay), the shift value of the representative point A in the first image is (ΔAx1, ΔAy1), and the shift value of the representative point A in the second image is (ΔAx2, ΔAy2) (see FIG. 9A and FIG. 9B). In this case, M(A) is given by

M(A)=|(Ax+ΔAx1,Ay+ΔAy1)−(Ax+ΔAx2,Ay+ΔAy2)|=|(ΔAx1−ΔAx2,ΔAy1−ΔAy2)|

### (see FIG. 9C).

Then the area L(A) for connecting is determined by

L(A)=α×M(A)

where α is an arbitrarily determined positive number.

If the relative difference between the shift of the representative point A from the true value in the first image and the shift of the representative point A from the true value in the second image is M(A)=4.5 (pixels) and α=10, L(A)=45(pixel) is established, and this means that 45 pixels are required for the connecting area. α is a parameter to determine the smoothness of connecting, and as the value of α increases, the connecting becomes smoother, but the overlapped area also increases, hence an appropriate value is arbitrarily determined.

L(B) and L(C) can be considered in the same manner. It is assumed that the true values of the representative points B and C are (Bx, By) and (Cx, Cy) respectively, and the shift values of the representative points B and C in the first image are (ΔBx1, ΔBy1) and (ΔCx1, ΔCy1), and the shift values of the representative points B and C in the second image are (ΔBx2, ΔBy2) and (ΔCx2, ΔCy2) respectively. In this case, M(B) and M(C) respectively are given by:

M(B)=|(Bx+ΔBx1,By+ΔBy1)−(Bx+ΔBx2,By+ΔBy2)|=|(ΔBx1−ΔBx2,ΔBy1−ΔBy2)|; and

M(C)=|(Cx+ΔCx1,Cy+ΔCy1)−(Cx+ΔCx2,Cy+ΔCy2)|=|(ΔCx1−ΔCx2,ΔCy1−ΔCy2)|.

Then the areas L (B) and L (C) for connecting are determined by:

L(B)=α×M(B); and

L(C)=α×M(C).

Then the maximum value out of L(A), L(B) and L(C) is determined as the width N of the correction area. For example, if the relationship of L(A), L(B) and L(C) is

L(A)>L(B)>L(C)

as shown in FIG. 8C, then the width N of the correction area is N=L(A).

By the above method, the size of each correction area is adaptively determined so that the correction area becomes smaller as the relative coordinate shift amount, due to distortion, becomes smaller. To be more specific, if the direction of arrangement of the two images being disposed side by side is the first direction, and a direction perpendicular to the first direction is the second direction, the width of the correction area in the first direction becomes narrower as the relative coordinate shift amount, due to distortion, becomes smaller. The correction area is created along the second direction, so as to cross the overlapped area. Here the three representative points on the center line of the overlapped area were considered, but the present invention is not limited to this, and the correction area can be more accurately estimated as the number of representative points increases.

There are eight overlapped areas in the case of the image merging in the horizontal direction of the first column (C1) of the overlapped area in FIG. 8A. The above mentioned correction area N is determined for each of these overlapped areas. Then the size of the overlapped area K in the first column (C1) is determined so as to be the same as or greater than the maximum correction area Nmax in the first column (C1). In other words, in the first column (C1), the overlapped area K is a common value, but the correction area N is a different value depending on each of the eight overlapped areas.

Applying the same concept to each column (C1 to C6) and each row (R1 to R7), the correction area is determined for each overlapped area, and the overlapped areas in each column and in each row are determined. In other words, each column and each row has an independent overlapped area, and each overlapped area has a different sized correction area. If the size of the overlapped area is the minimum value required, as described here, the imaging sensor can be downsized, and the capacities of the color memory and the sensor memory can be decreased, which is an advantage. However the sizes of all the overlapped areas may be set to a same value.

Here the shift from the true value was described as a coordinate shift generated due to the influence of distortion, but the description is applicable to the case of a pixel value shift as well, not only to the case of coordinate shift.

Based on the above concept, the correction area in each overlapped area is determined. The merits of setting the correction area in the overlapped area follow. First, if the position is shifted in the obtained image, the position can be corrected with the image information by using such a method as characteristic extraction for the two images. Second, the coordinate values and pixel values can be referred to in the two images, hence correction accuracy can be improved and the images can be smoothly connected.

### (Processing to Determine Correction Area and Overlapped Area)

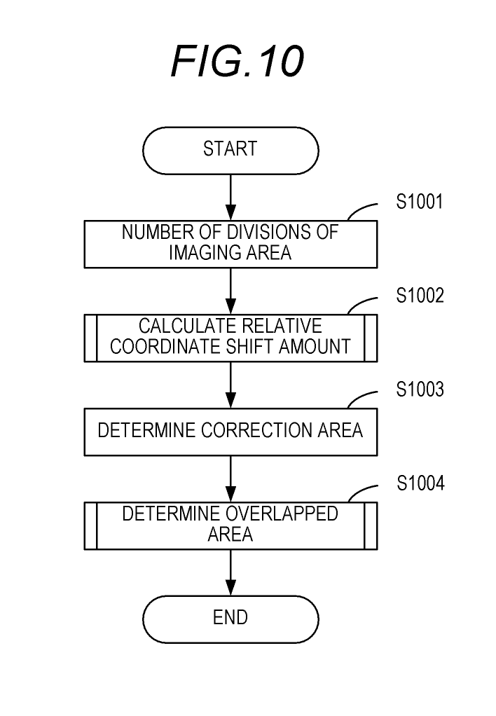

FIG. 10 is a flow chart depicting a flow of processing to determine the correction area and the overlapped area.

In step S1001, a number of division in the imaging area is set. In other words, how the imaging target area image 110b is divided by the image sensor group 111a to 111q is set. In FIG. 7B, the imaging target area image 110b is divided into 8×7=56 areas. This number of divided areas is determined by the relationship of a general size of the two-dimensional sensor and a size of the imaging target area image 110b. First, sizes in the X direction and the Y direction, that can be imaged by one two-dimensional image sensor, are estimated based on the pixel pitch and resolution of the two-dimensional image sensor to be used. Then a number of divisions, with which at least the imaging target area image 110b can be perfectly imaged, is estimated. Here the boundary line between divided areas becomes a center line of the overlapped area shown in FIG. 8B and FIG. 8C. Images are connected using the boundary line of the divided areas, that is, the center line of the overlapped area, as a reference.

In step S1002, the relative coordinate shift amount is calculated. In the representative points in each column and each row, a relative difference of the shifts from the true value between the connecting target images is calculated. The shift from the true value refers to the coordinate shift, which is generated due to the influence of the distortion. The calculation method is as described in FIG. 9.

In step S1003, the correction area is determined for each overlapped area. The method for determining the correction area is as described in FIG. 8. The size of the overlapped area, however, has not yet been determined at this stage.

In step S1004, the overlapped area is determined for each row and each column. The maximum correction area is determined based on the maximum relative coordinate shift value in each row and each column, and a predetermined margin area is added to the maximum correction area in each row and each column to determine the respective overlapped area. Here the overlapped area has the same size in each row and each column, since same sized two-dimensional image sensors are used for the image sensor group 111a to 111q. The method for determining the margin area will be described later.

By the above mentioned processing steps, the correction area in each overlapped area is determined.

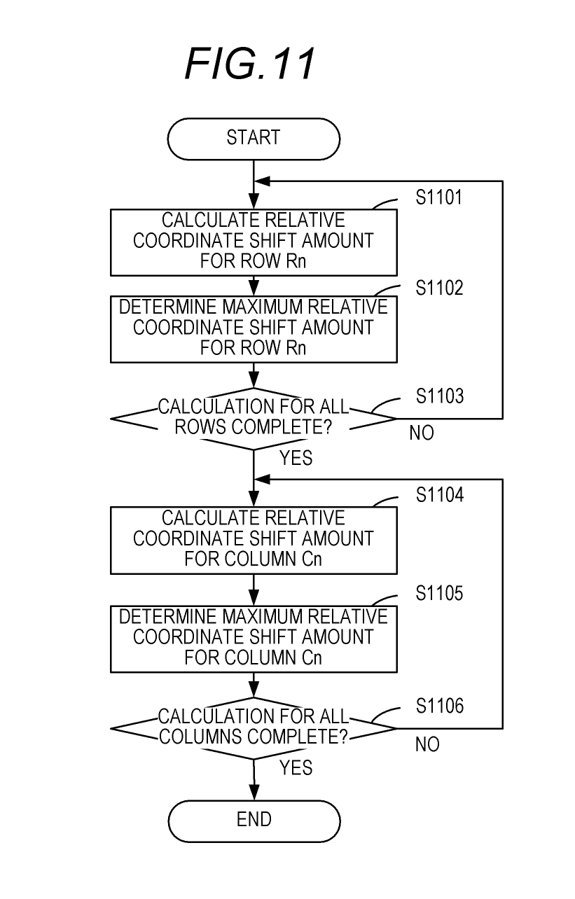

FIG. 11 is a flow chart depicting the detailed flow of calculation of the relative coordinate shift amount in step S1002 in FIG. 10.

In step S1101, the relative coordinate shift amount is calculated for the row Rn. For the representative points on the center line of the overlapped area, the relative difference of the shifts from the true value between the connecting target images is calculated. In step S1102, the maximum relative coordinate shift amount is determined for the row Rn based on the result in S1101. In step S1103, it is determined whether the calculation of the relative coordinate shift amount for all the rows, and determination of the maximum relative coordinate shift amount for each row, are completed. Steps S1101 and S1102 are repeated until the processing is completed for all the rows. In step S1104, the relative coordinate shift amount is calculated for the column Cn. For the representative points on the center line of the overlapped area, the relative difference of the shifts from the true value between the connecting target images is calculated. In step S1105, the maximum relative coordinate shift amount is determined for the column Cn based on the result in S1104. In step S1106, it is determined whether the calculation of the relative coordinate shift amount for all the columns, and the determination of the maximum relative coordinate shift amount for each column, are completed. Steps S1104 and S1105 are repeated until the processing is completed for all the columns. By the above processing steps, the relative coordinate shift amount is calculated for the representative points on the center line of the overlapped area, and the maximum relative coordinate shift amount is determined for each row and each column.

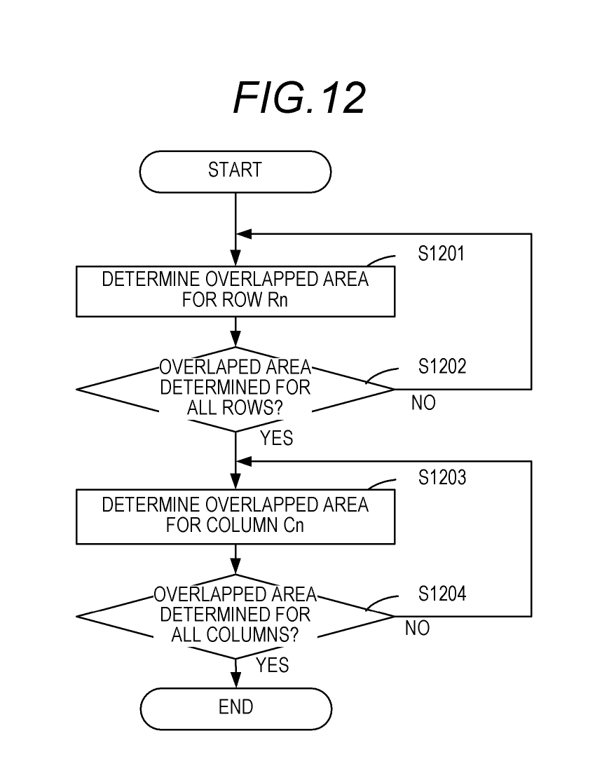

FIG. 12 is a flow chart depicting the detailed flow of determining the overlapped area in step S1004 in FIG. 10.

In step S1201, the overlapped area is determined for the row Rn. Based on the determination of the correction areas in S1003, an area of which correction area is largest in each row is regarded as the overlapped area. In step S1202, it is determined whether the determination of the overlapped area is completed for all the rows. Step S1201 is repeated until the processing is completed for all the rows. In step S1203, the overlapped area is determined for the column Cn. Based on the determination of the correction areas in S1003, an area of which correction area is largest in each column is regarded as the overlapped area. In step S1204, it is determined whether the determination of the overlapped area is completed for all the columns. Step S1203 is repeated until the processing is completed for all the columns. By the above processing steps, the overlapped area is determined for each row and each column.

The processings described in FIG. 8 to FIG. 12 are processing steps to determine the correction areas and overlapped areas, but also to determine the arrangement and sizes of the image sensor group 111a to 111q. This will be described with reference to FIGS. 7A and 7B. In the case of the image sensor 111h, for example, the size of the light receiving surface of this image sensor in the X direction is determined by the overlapped areas in the first column (C1) and the second column (C2). The size of the light receiving surface of the image sensor 111h in the Y direction is determined by the overlapped areas in one of the combinations of the second row (R2) and the third row (R3), the third row (R3) and the fourth row (R4), the fourth row (R4) and the fifth row (R5), and the fifth row (R5) and the sixth row (R6), with which the size becomes largest. The image sensor is designed or selected so as to match the sizes of the light receiving surface in the X direction and the Y direction of the image sensor determined like this, and this image sensor is disposed on this area. Here the overlapped area (data overlapped area) according to the present invention is an area where the image data is redundantly obtained, and critical here is that the data overlapped area is different from the overlapped area actually generated in the two-dimensional image sensors (physical overlapped area). The physical overlapped area at least includes the data overlapped area. According to the present embodiment, the data overlapped area (C1 to C6) in the X direction can be matched with the physical overlapped area if two-dimensional image sensors having different sizes are used for the image sensor group 111a to 111q, but the data overlapped area (R1 to R7) in the Y direction, which is the moving direction, does not always match with the actual overlapped area. If the physical overlapped area is larger than the data overlapped area, the data overlapped area can be implemented by ROI (Region Of Interest) control of the two-dimensional image sensors.

### (Correction Processing)

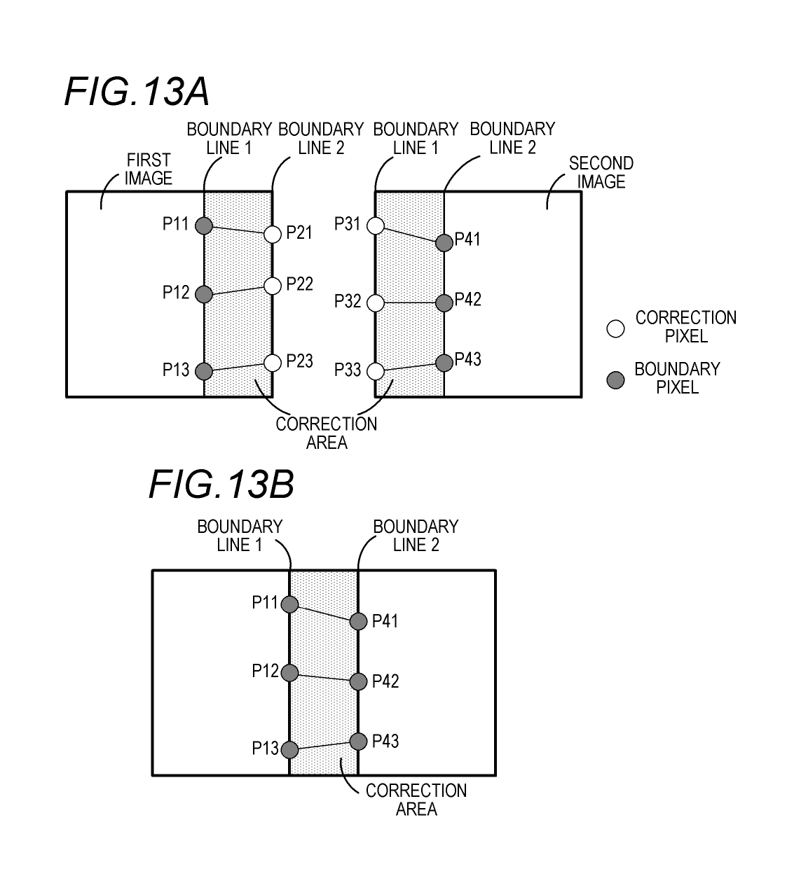

FIGS. 13A and 13B are schematic diagrams depicting an example of the correction processing. In FIG. 8 to FIG. 12, a method for setting a range of the correction area was described, but here, how images are connected in the correction range being set will be described in brief.

FIG. 13A shows a first image and a second image to be the target of image connecting. The overlapped area is omitted here, and only the correction area is illustrated. The boundary of the correction area on the first image side is called “boundary line 1”, and the boundary on the second image side is called “boundary line 2”. P11 to P13 are points on the boundary line 1 in the first image, and P31 to P33 are points on the boundary line 1 in the second image, which correspond to P11 to P13. P41 to P43, on the other hand, are points on the boundary line 2 in the second image, and P21 to P23 are points on the boundary line 2 in the first image, which correspond to P41 to P43. The basic concept of connecting is that interpolation processing is performed on the pixels within the correction area, without processing the pixels on the boundary line 1 in the first image (e.g. P11, P12, P13) and pixels on the boundary line 2 in the second image (e.g. P41, P42, P43). For example, interpolation processing is performed on the correction area of the first image and the correction area of the second image, and the images are merged by α blending, so that the connecting on the boundary lines becomes smooth.

In the case of performing interpolation processing on the first image, the position of the coordinates P21 is transformed into the position of the coordinates P41. In the same way, the coordinates P22 are transformed into the coordinates P42, and the coordinates P23 are transformed into the coordinates P43. The coordinates P21, P22 and P23 need not match with each barycenter of the pixel, but the positions of P41, P42 and P43 match with each barycenter of the pixel. Here only the representative points are illustrated, but actual processing is performed on all the pixels on the boundary line 2 in the first image. Considering interpolation processing to be performed on the second image, the position of the coordinates P31 is transformed into the position of the coordinates P11. In the same way, the coordinates P32 are transformed into the coordinates P12, and the coordinates P33 are transformed into the coordinates P13. The coordinates P31, P32 and P33 need not match each barycenter of the pixel, but the positions of the coordinates P11, P12 and P13 match with each barycenter of the pixel. Here only representative points are illustrated, but actual processing is performed on all the pixels on the boundary line 1 in the second image. Since the correction image is generated for the first image and the second image respectively like this, image merging with smooth seams can be implemented using α blending, where the ratio of the first image is high near the boundary line 1, and the ratio of the second image is high near the boundary line 2.

FIG. 13B shows an example of generating coordinate information in the correction area by simply connecting the coordinate values between the boundary line 1 and the boundary line 2 with straight lines, and determining a pixel value in the coordinates by interpolation. A method of generating coordinate information is not limited to this, but coordinate information of the correction area may be interpolated using coordinate information in the overlapped area, other than the correction area, in the first image, and coordinate information in the overlapped area, other than the correction area, in the second image. Then generation of more natural coordinates can be expected compared with the above mentioned interpolation using simple straight lines.

The interpolation processing here is performed based on the coordinate information which is held in advance. As FIG. 7A shows, coordinate information of design values may be held regarding distortion in each image sensor as a known, or actually measured distortion information may be held.

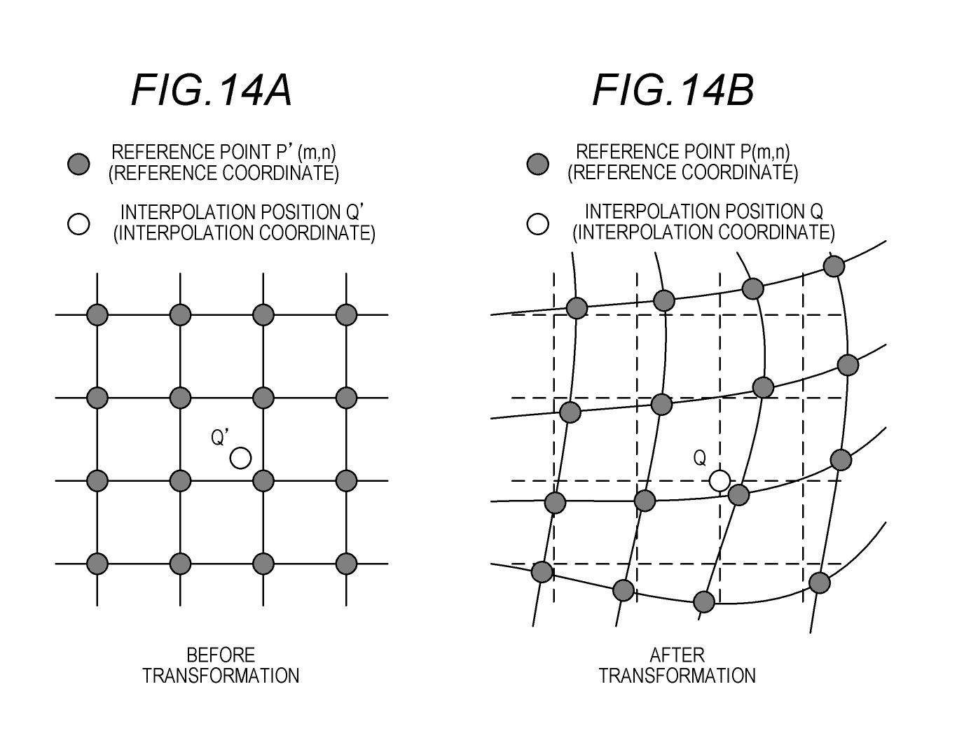

FIGS. 14A and 14B are schematic diagrams depicting interpolation coordinates and reference coordinates. FIG. 14A illustrates the positional relationship between the interpolation coordinates Q′ and the reference coordinates P′ (m, n) before coordinate transformation. FIG. 14B illustrates the positional relationship between the interpolation coordinates Q and the reference coordinates P (m, n) after coordinate transformation.

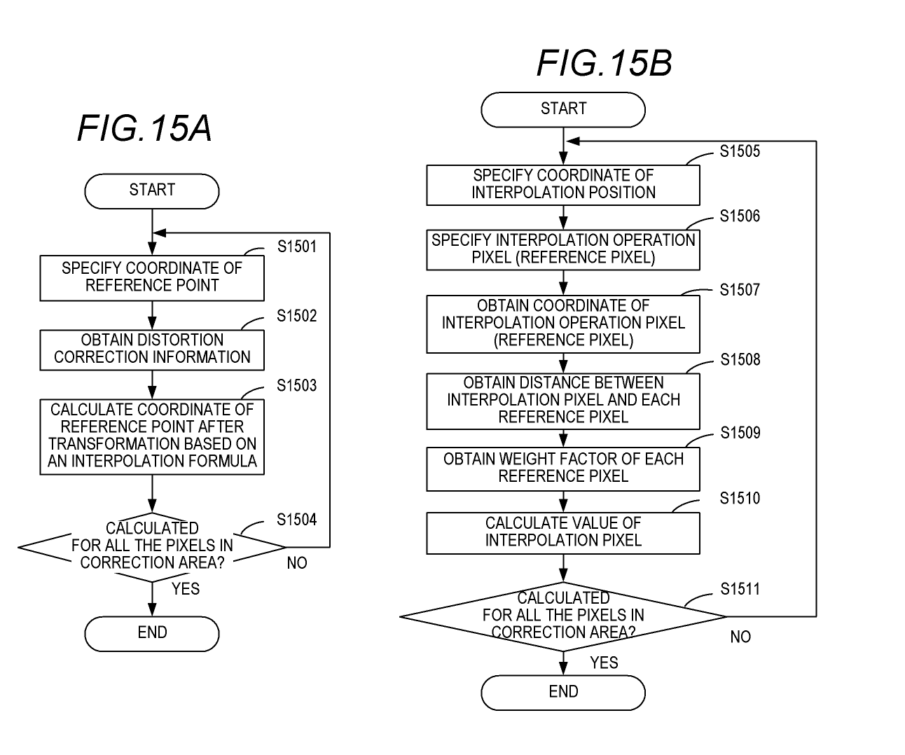

FIG. 15A is a flow chart depicting an example of a flow of coordinate transformation processing.

In step S1501, coordinates P′ (m, n), which is a reference point, are specified.

In step S1502, a correction value, which is required to obtain the address P (m, n) after transforming the reference point, is obtained from an aberration correction table. The aberration correction table is a table holding the correspondence of positions of pixels before and after coordinate transformation. Correction values for calculating coordinate values after transformation, corresponding to coordinates of a reference point, are stored.

In step S1503, coordinates P (m, n) after transformation of the reference pixel are obtained based on the values stored in the aberration correction table obtained in the processing in step S1502. In the case of distortion, coordinates after transformation of the reference pixel are obtained based on the shift of the pixel. If values stored in the aberration correction table, that is reference points, are values of the selected representative points (representative values), a value between these representative points is calculated by interpolation.

In step S1504, it is determined whether coordinate transformation processing is completed for all the processing target pixels, and if the processing is completed for all the pixels, this coordinate transformation processing is ended. If not completed, the processing step returns to step S1501, and the above mentioned processing is executed repeatedly. By these processing steps, the coordinate transformation processing is performed.

Here the correspondence when the position of the coordinates P21 is transformed into the position of the coordinates P41 in FIG. 13A is described. If the coordinates P21 perfectly match the barycenter of the pixel, the processing to transform the position of the coordinates P21 into the position of the coordinates P41 is performed, but if the coordinates P21 do not match the barycenter of the pixel, the coordinate interpolation processing shown in FIG. 15 is performed. The coordinates Q at the interpolation position in this case are P41, the interpolation coordinates Q′ before the coordinate transformation are the coordinates P21, and the coordinates P′ (m, n) of the reference pixels are those of 16 pixels around the coordinates P21.

FIG. 15B is a flow chart depicting the flow of the pixel interpolation processing.

In step S1505, the coordinates Q, which are the position where interpolation is performed, are specified.

In step S1506, several to several tens of reference pixels P (m, n) around the pixel generated in the interpolation position are specified.

In step S1507, coordinates of each of the peripheral pixels P (m, n), which are reference pixels, are obtained.

In step S1508, the distance between the interpolation pixel Q and each of the reference pixels P (m, n) is determined in vector form, of which origin is the interpolation pixel.

In step S1509, a weight factor of each reference pixel is determined by substituting the distance calculated in the processing in step S1508 for the interpolation curve or line. Here it is assumed that a cubic interpolation formula, the same as the interpolation operation used for coordinate transformation, is used, but a linear interpolation (bi-linear) algorithm may be used.

In step S1510, a product of the value of each reference pixel and the weight factor in the x and y coordinates is sequentially added, and the value of the interpolation pixel is calculated.

In step S1511, it is determined whether the pixel interpolation processing is performed for all the processing target pixels, and if the processing is completed for all the pixels, this pixel interpolation processing ends. If not completed, processing step returns to step S1505, and the above mentioned processing is executed repeatedly. By these processing steps, the pixel interpolation processing is performed.

Considering the case of performing the coordinate transformation processing and the pixel interpolation processing on the correction area shown in FIGS. 13A and 13B, it is simple to use the pixel values and coordinate values in the overlapped area of the first image and the second image. For this, the boundary line 1, the boundary line 2 and the reference pixels for processing the peripheral area thereof must be secured in the overlapped area. This is because pixels outside the overlapped area are not referred to, in the case of the configuration to divide areas and execute processing at high-speed, as shown in FIG. 6. The margin area described in step S1004 in FIG. 10 is an area for securing this reference pixel group. By performing the coordinate transformation and pixel interpolation on the first image and the second image respectively and α-blending these images, the images can be merged smoothly, making the seams around the boundary lines unnoticeable.

### Advantages of this Embodiment

The characteristic preconditions and configuration of the imaging apparatus of the present embodiment will now be described, and the technical effects thereof will be referred to.

The imaging apparatus of the present embodiment in particular is targeted for use as a virtual slide apparatus in the field of pathology. The characteristics of digital images of samples obtained by the virtual slide apparatus, that is, enlarged images of tissues and cells of the human body, indicate that there are not many geometric patterns, such as straight lines, hence image distortion does not influence the appearance of an image very much. In order to improve the diagnostic accuracy in pathological diagnosis, on the other hand, resolution deterioration due to image processing should be minimized. Because of these preconditions, priorities are assigned to image design to secure resolution, rather than to minimize the influence of the distortion of images in image connecting, so that an area where resolution is deteriorated by image correction can be decreased.

The imaging apparatus of the present embodiment has a configuration for dividing an imaging area and imaging the divided areas using a plurality of two-dimensional image sensors which are discretely disposed within a lens diameter including the imaging area, and merging the plurality of divided images to generate a large sized image.

In the case of a configuration of a multi-camera in which same sized cameras having a same aberration are regularly disposed, lens aberration of the two cameras in the overlapped area approximately match in the row direction and in the column direction. Therefore image merging in the overlapped area can be handled using a fixed processing in the row direction and in the column direction respectively. However in the case of using a plurality of two-dimensional image sensors, which are discretely disposed within the lens diameter including the imaging area, lens aberrations of the two two-dimensional image sensors differ depending on the overlapped area.

In the case of panoramic photography having another configuration, the overlapped area can be controlled freely. However in the case of using a plurality of two-dimensional image sensors which are discretely disposed within a lens diameter including the imaging area, the overlapped area is fixed, just like the case of the multi-camera.

In this way, the imaging apparatus of the present embodiment has a characteristic that the multi-camera and panoramic photography do not possess, that is, the overlapped area is fixed, but the lens aberrations of the two-dimensional image sensors are different depending on the overlapped area. The effect of this configuration in particular is that an area where resolution is deteriorated can be minimized by adaptively determining the correction area in each overlapped area according to the aberration information.

The effect of the present embodiment described above is based on the preconditions that an imaging area is divided and the divided area is imaged using a plurality of two-dimensional image sensors which are discretely disposed within a lens diameter including the imaging area, and the plurality of divided images are merged to generate a large sized image. In the merging processing (connecting processing) of the divided images, the correction area is adaptively determined according to the aberration information to perform correction, hence an area where resolution is deteriorated due to image correction can be decreased.

### Second Embodiment

Now the second embodiment of the present invention will be described. In the first embodiment mentioned above, the correction area is determined according to the largest relative coordinate shift amount in the overlapped areas. In other words, the width of the correction area is constant. Whereas in the second embodiment, the correction area is adaptively determined within the overlapped area according to the relative coordinate shift amount of the center line of the overlapped area. Thereby the width of the correction area changes according to the relative coordinate shift amount. Thus the only difference between the present embodiment and the first embodiment mentioned above is the approach to determine the correction area. Therefore in the description of the present embodiment, a detailed description on portions the same as the first embodiment is omitted. For example, the configuration and processing sequence of imaging and image merging of the imaging apparatus shown in FIG. 1A to FIG. 6, the example of distortion and the example of combination of images shown in FIGS. 7A and 7B, the processing steps for determining the correction area and the overlapped area shown in FIG. 10 to FIG. 12, the example of correction method shown in FIGS. 13A and 13B, and the coordinate transformation processing and the pixel interpolation processing depicted in FIGS. 14A and 14B, and FIGS. 15A and 15B, are the same as the first embodiment.

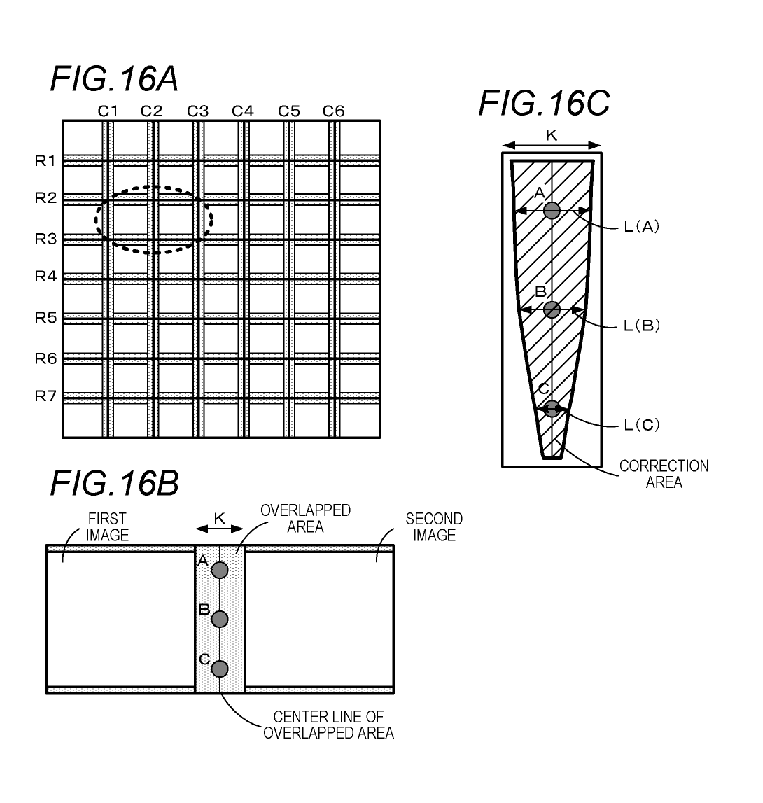

The method for determining the correction area according to the present embodiment will now be described with reference to FIGS. 9A to 9C, and FIGS. 16A to 16C. FIGS. 16A and 16B are the same as FIGS. 8A and 8B of the first embodiment, hence primarily FIG. 16C will be described.

FIG. 16C is a diagram extracting only the overlapped area from the FIG. 16B.

L (A) is a width required for smoothly connecting the first image and the second image at the representative point A, and is determined by the same method as the first embodiment. This is the same for L (B) and L (C).

As FIG. 16C shows, the correction area is generated by continuously connecting the range of L(A), L(B) and L(C). Linear interpolation is or various nonlinear interpolations are used to connect the correction width at each representative point. Here three representative points on the center line of the overlapped area are considered to simplify description, however the present invention is not limited to this, and the correction area can be more accurately estimated as the number of representative points increases, since the area estimated by interpolation decreases.

The above mentioned correction area, which adaptively changes according to the relative coordinate shift amount of the center line of the overlapped area, is determined for the first column (C1) of the overlapped area in FIG. 16A. Then the size of the overlapped area K in the first column (C1) is determined so as to be the same or larger than the maximum correction area in the first column (C1). Applying this concept to each column (C1 to C6) and to each row (R1 to R7), the correction area is determined for each column and each row, and the respective overlapped area is determined based on the maximum correction area among the determined correction areas. In other words, each row and each column has an independent overlapped area respectively, and the correction area has a size which adaptively changes according to the relative coordinate shift amount of the center line of the overlapped area.

Here the shift from the true value was described as a coordinate shift generated due to the influence of distortion, but the description is applicable to the case of a pixel value shift as well, and not just the case of the coordinate shift.

According to the present embodiment described above, the correction area can be further decreased than the case of the first embodiment, therefore the area in which resolution deteriorates due to image correction can be further decreased.

### Third Embodiment

Now the third embodiment of the present invention will be described. In the first embodiment and the second embodiment mentioned above, the method for determining the correction area based on the representative points on the center line of the overlapped area was described. Whereas in the third embodiment, the position of the correction area is adaptively determined based on the correction of two images in the overlapped area. The difference from the first embodiment and the second embodiment is that the calculation of the relative coordinate shift amount does not depend on the center line of the overlapped area. Thus the only difference of the present embodiment from the first and second embodiments is the method for determining the correction area. Therefore in the description of the present embodiment, a detailed description of the portions the same as the first embodiment is omitted. For example, the configuration and the processing sequence of imaging and image merging of the imaging apparatus shown in FIG. 1A to FIG. 6, the example of distortion and the example of combination of images shown in FIGS. 7A and 7B, the processing steps for determining the correction area and the overlapped area shown in FIG. 10 to FIG. 12, the example of the correction method shown in FIGS. 13A and 13B, and the coordinate transformation processing and the pixel interpolation processing depicted in FIGS. 14A and 14B, and FIGS. 15A and 15B are the same as the first embodiment.

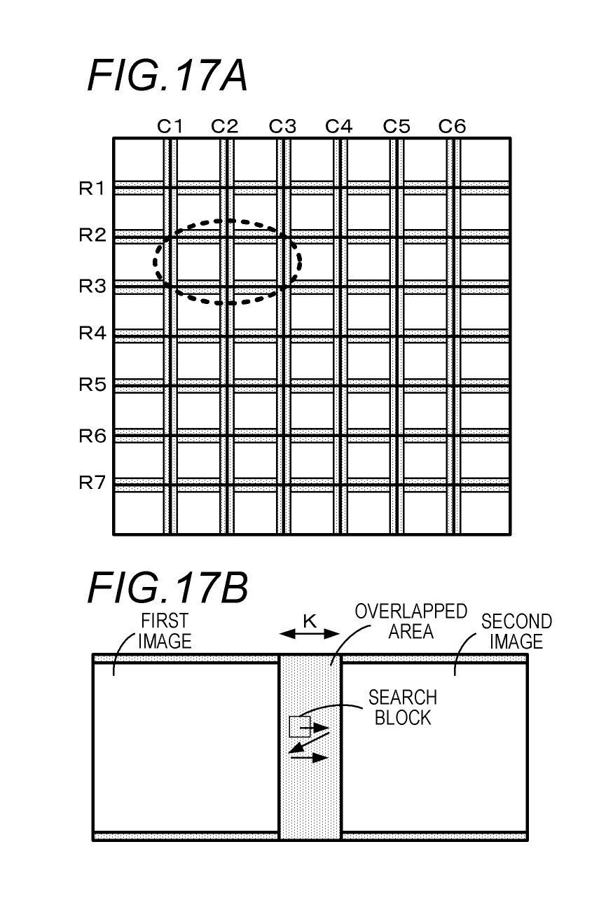

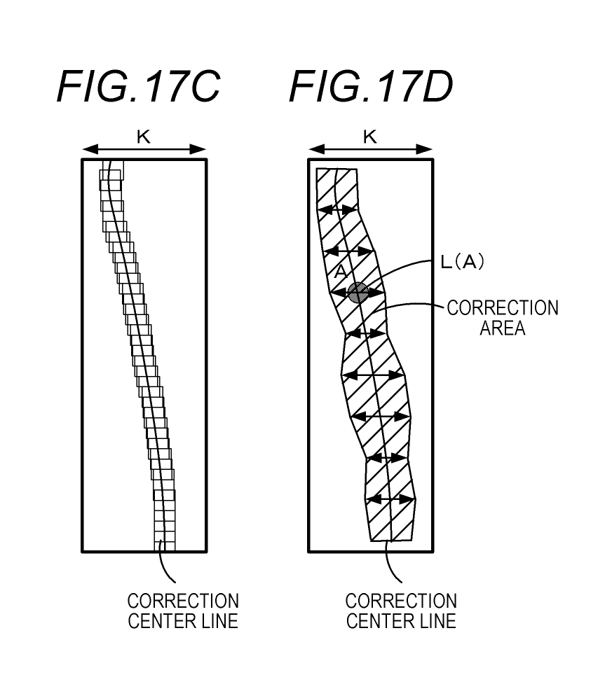

The method for determining the correction area according to the present embodiment will now be described with reference to FIGS. 17A to 17D. FIG. 17A is the same as FIG. 8A in the first embodiment. Now primarily FIG. 17B, FIG. 17C and FIG. 17D, which are different from the first embodiment, will be described.

FIG. 17B is a diagram extracting the dotted portion of FIG. 17A, considering the horizontal image merging. Regarding correspondence with FIG. 5A, the extracted area corresponds to the areas (A, B, C, D, E, F) in FIG. 5A, the first image corresponds to area 1 (A, B, D, E), the second image corresponds to area 2 (B, C, E, F), and the overlapped area corresponds to area (B, E). The overlapped areas located in the upper part of the first image and the second image are omitted in FIG. 5A to simplify the description, but are shown in FIG. 17B. Regarding correspondence with FIG. 7A, the first image is the image obtained by the image sensor 111h, and the second image is the image obtained by the image sensor 111e. Therefore the first image is influenced by the distortion due to the arrangement of the image sensor 111h in the lens, and the second image is influenced by the distortion due to the arrangement of the image sensor 111e in the lens.

First in the overlapped area having width K, hierarchical block matching is performed between the first image and the second image, whereby the portion where the correlation of these images is highest (portion where these images are most similar) is detected. In concrete terms, the correlation (degree of consistency) between the first image and the second image in the search block is determined at each position, while gradually shifting the position of the search block in the horizontal direction, and detecting a position where the correlation is highest. By performing this processing at a plurality of positions in the vertical direction in the overlapped area, a block group where correlation between the first image and the second image is high can be obtained. FIG. 17C is a diagram extracting only the overlapped area from FIG. 17B, and shows a block group where correlation between the first image and the second image is high. An SAD (Sum of Absolute Differences) function for pixel values or an SSD (Sum of Squared Differences) function for pixel values can be used to evaluate the correlation between blocks.

Now as FIG. 17C shows, a correction center line is derived from the block group where correlation is high. The correction center line is determined by connecting the barycenter of each block, or by interpolating the barycenter of each block with a straight line or a curved line. The correction center line determined like this is a boundary where the first image and the second image are most similar, in other words, a boundary where the shift between the first image and the second image is smallest. Therefore the size of the correction area can be minimized by determining the correction area using the correction center line as a reference. The case of horizontal image merging was described above, but in the case of vertical image merging, vertical block matching is performed, whereby the correction center line is determined in the same manner.

FIG. 17D illustrates a correction area generated by calculating the correction width L(A) required for connecting at a plurality of points A on the correction center line, and connecting these widths. A is an arbitrarily selected point on the correction center line. L(A) is calculated by the same method as the first embodiment.

The correction area N, which adaptively changes according to the above mentioned relative coordinate shift amount of the correction center line, is determined for the first column (C1) of the overlapped area in FIG. 17A. Then the maximum width of the correction area determined for the first column (C1) becomes the overlapped area K in the first column (C1). Applying the same concept to each column (C1 to C6) and each row (R1 to R7), the correction area is determined for each column and for each row, and the respective overlapped area is determined based on the maximum width of these correction areas. In other words, each row and each column has an independent overlapped area respectively, and the correction area has a size which adaptively changes according to the relative coordinate shift amount of the correction center line.

According to the present embodiment, the overlapped area, which is temporarily set for searching with the search block, and the final overlapped area, which is determined based on the maximum width of the correction area, must be set separately. The connecting becomes smoother as the temporarily determined overlapped becomes large, but if it is too large, the final overlapped area may become large, hence an appropriate numeric value is set arbitrarily.

According to the present embodiment described above, the correction area can be even smaller than the first and second embodiments, therefore the area where resolution deteriorates due to image correction can be further decreased.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-273386, filed on Dec. 8, 2010 and Japanese Patent Application No. 2011-183092, filed on Aug. 24, 2011, which are hereby incorporated by reference herein in their entirety.

What is claimed is:

1. An imaging apparatus comprising:
a supporting unit which supports an object;
an imaging unit which has a plurality of image sensors discretely disposed with spacing from one another;
an imaging optical system which enlarges an image of the object and guides the image to the imaging unit, and of which relative position with the plurality of image sensors is fixed;
a moving unit which changes the relative position between the plurality of image sensors and the object, so as to perform a plurality of times of imaging while changing imaging positions of the plurality of image sensors with respect to the image of the object; and
a merging unit which connects a plurality of images obtained from respective image sensors at respective imaging positions, and generates an entire image of the object, wherein
aberration of the imaging optical system in an image obtained by each image sensor is predetermined for each image sensor based on the relative position between the imaging optical system and the image sensor,
the moving unit changes the relative position between the plurality of image sensors and the object so that the two images to be connected partially overlap,
the merging unit smoothes seams of the two images by setting a correction area in an overlapped area where the two images to be connected overlap with each other, and performing correction processing on pixels in the correction area, and
a size of the correction area is determined according to the difference in aberrations of the two images, which is determined by a combination of image sensors which have imaged the two images to be connected.

2. The imaging apparatus according to claim 1, wherein the size of the correction area is determined so that the correction area becomes smaller as a relative coordinate shift amount due to distortions in the two images becomes smaller.

3. The imaging apparatus according to claim 1, wherein when the direction of arrangement of the two images to be connected is defined as a first direction and a direction perpendicular to the first direction is a second direction, the correction area is an area of which width in the first direction is narrower than the overlapped area, and which is disposed along the second direction so as to cross the overlapped area.

4. The imaging apparatus according to claim 3, wherein the width of the correction area in the first direction is determined to be narrower as the relative coordinate shift amount due to distortion in the two images is smaller.

5. The imaging apparatus according to claim 3, wherein the width of the correction area in the first direction is constant regardless the position of the second direction.

6. The imaging apparatus according to claim 3, wherein
the width of the correction area in the first direction is different according to the relative coordinate shift amount due to the distortion in each position in the second direction.

7. The imaging apparatus according to claim 3, wherein the position of the correction area in the first direction is determined so that the correlation between the two images becomes the highest in the overlapped area.

8. The imaging apparatus according to claim 1, wherein
the plurality of image sensors are regularly arranged in a row direction and a column direction, and
the size of the overlapped area is determined depending on each row and each column.
